(19) United States
(12) Patent Application Publication
(10) Pub. No.: US 2013/0313099 A1
(43) Pub. Date: Nov. 28, 2013

(54) OPERATING SWITCH

(71) Applicant: TOYOTA BOSHOKU KABUSHIKI KAISHA, Aichi-ken (JP)

(72) Inventors: Shinichiro KOMAKI, Aichi-ken (JP); Hiroshi MURAHATA, Aichi-ken (JP)

(73) Assignee: TOYOTA BOSHOKU KABUSHIKI KAISHA, Aichi-ken (JP)

(21) Appl. No.: 13/901,866

(22) Filed: May 24, 2013

(30) Foreign Application Priority Data
May 28, 2012 (JP) 2012-120912

(51) Int. Cl. H01H 1/64

(52) U.S. Cl. CPC H01H 1/64
USPC 200/600

(57) ABSTRACT

An operating switch provided on a vehicle seat includes a first conductive cloth that includes a wire material that is able to carry current, and functions as a touch sensor that detects an input medium approaching or contacting with the conductive cloth, a second conductive cloth provided below the first conductive cloth and capable of absorbing electromagnetic wave, and an insulating cloth inserted between the two conductive cloths. The second conductive cloth absorbs electromagnetic waves, and can prevent malfunction of the first conductive cloth that functions as a touch sensor.

### INCORPORATION BY REFERENCE

The disclosure of Japanese Patent Application No. 2012-120912 filed on May 28, 2012 including the specification, drawings and abstract is incorporated herein by reference in its entirety.

### BACKGROUND OF THE INVENTION

1. Field of the Invention

The invention relates to an operating switch, and more particularly to an operating switch provided on a vehicle seat.

2. Description of Related Art

One type of vehicle seat, such as a power seat, is equipped with a mechanism for electrically adjusting the seat position, and another type of vehicle seat is equipped with a mechanism, such as a seat heater, for adjusting the seat temperature. In these types of vehicle seats, an operating switch may be provided for operating each of the mechanisms. In recent years, a sheet-shaped member having electric conductivity has been developed, and a technology of providing the sheet-shaped member having conductivity on a vehicle seat and using the sheet-shaped member as a sensor for detecting an input medium approaching or contacting with the sheet-shaped member is described in Japanese Patent Application Publication No. 2010-261143 (JP 2010-261143 A). Namely, the sheet-shaped member having conductivity, which functions as a touch sensor for detecting an input medium that comes close to or moves away from the sheet-shaped member, can be used as an operating switch of the vehicle seat.

The use of the conductive sheet-shaped member as the operating switch of the vehicle seat makes it possible to directly attach the operating switch to a seat cushion, a seat back, or the like, and also makes it possible to place the operating switch at various positions on the seat. Also, the operating switch can be housed within the seat cushion, seat back, or the like, and poor appearance due to the placement of the operating switch can be resolved. In the meantime, various devices are provided within the vehicle, and the conductive sheet-shaped member that functions as a touch sensor may react with electromagnetic waves generated from these devices, which may result in malfunction of the power seat, for example.

### SUMMARY OF THE INVENTION

The invention provides an operating switch that uses a sheet-shaped member having conductivity, and is less likely to be affected by electromagnetic waves. An operating switch according to one aspect of the invention, which is provided on a vehicle seat, includes a fabric electrode that includes a wire material that is able to carry electric current, and functions as a touch sensor that detects an input medium approaching or contacting with the fabric electrode, an electromagnetic wave absorber capable of absorbing electromagnetic wave, and a spacer that has an insulating property and is inserted between the fabric electrode and the electromagnetic wave absorber.

The operating switch according to the above aspect of the invention has a fabric electrode including a wire material that is able to carry electric current, and the fabric electrode functions as a touch sensor that detects an input medium approaching or contacting with the fabric electrode. With this arrangement, the operating switch can be placed at various positions on the seat, and poor appearance due to the placement of the operating switch can be resolved. Also, the electromagnetic wave absorber capable of absorbing electromagnetic wave is provided below the fabric electrode, and the fabric electrode and the electromagnetic wave absorber are electrically insulated from each other by the spacer. Thus, in the operating switch according to the above aspect of the invention, the electromagnetic wave absorber insulated from the fabric electrode can efficiently absorb electromagnetic waves, so as to prevent malfunction of the power seat, for example.

In the operating switch according to the above aspect of the invention, each of the electromagnetic wave absorber and the spacer may be a sheet-shaped member.

With this arrangement, when the operating switch is housed within the seat, more specifically, when the operating switch is inserted between a pad formed from urethane foam, for example, and a seat cover that covers the pad, a sense of unevenness or roughness the user feels at the location where the operating switch is inserted, and an uncomfortable feeling, or the like, in touching at the location where the operating switch is inserted, can be suppressed or eased.

In the operating switch according to the above aspect of the invention, the electromagnetic wave absorber may be a sheet-shaped member comprising a wire material that is able to carry electric current, and the ratio of an area occupied by the wire material that constitutes the fabric electrode, to a surface area of the fabric electrode, may be smaller than the ratio of an area occupied by the wire material that constitutes the electromagnetic wave absorber, to a surface area of the electromagnetic wave absorber.

With the above arrangement, the fabric electrode in which the wire material is provided at a relatively low density is less likely to be affected by electromagnetic waves, and the electromagnetic wave absorber in which the wire material is provided at a relatively high density is able to effectively absorb electromagnetic waves.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view showing a vehicle seat provided with operating switches according to one embodiment of the invention, as seen from a viewpoint located diagonally to the front of the vehicle;

FIG. 2 is a cross-sectional view taken along line A-A shown in FIG. 1;

FIG. 3 is an enlarged cross-sectional view of a conductive cloth shown in FIG. 2; and

FIG. 4 is a perspective view showing a vehicle seat provided with a side shield having no cutout portion, as seen from a viewpoint located diagonally to the front of the vehicle.

### DETAILED DESCRIPTION OF EMBODIMENTS

One embodiment of the invention will be described in detail, with reference to the drawings.

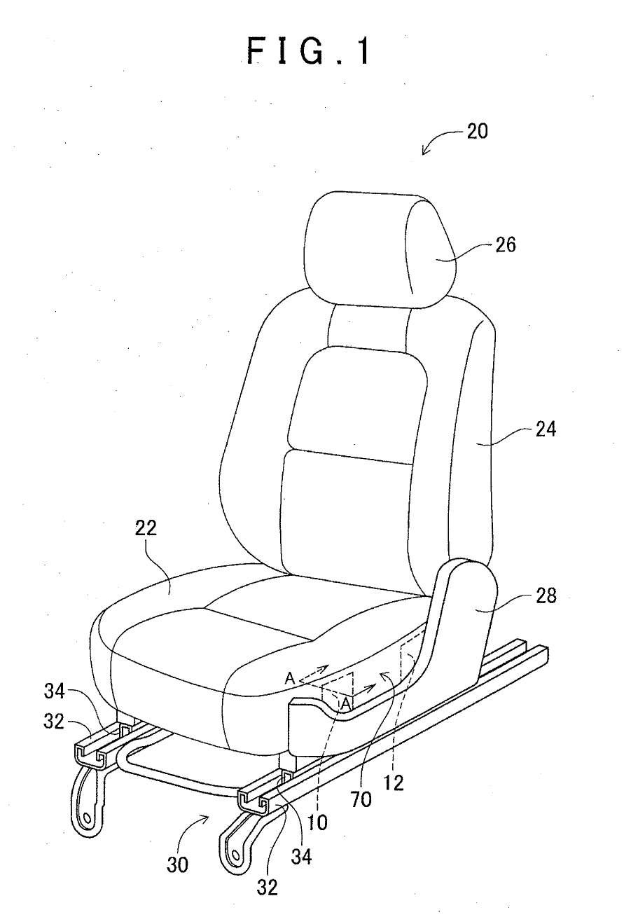

In FIG. 1, a vehicle seat 20 provided with a pair of operating switches 10, 12 according to one embodiment of the invention is illustrated as seen from a viewpoint located diagonally to the front of the seat. The vehicle seat 20 consists principally of a seat cushion 22 that supports the hips of a driver, a seat back 24 that supports the back of the driver, a head rest 26 provided on the upper end of the seat back 24 for supporting the head of the driver, and a side shield 28 that covers a side face of the seat cushion 22. The vehicle seat 20 is constructed as a so-called power seat, of which various seating positions or postures can be electrically adjusted, and each of the operating switches 10, 12 is operable to adjust the position of the vehicle seat 20 in the longitudinal direction.

A slide mechanism 30 is employed as a mechanism for changing the position of the vehicle seat 20 in the longitudinal direction. The slide mechanism 30 has lower rails 32 fixed to the floor of the vehicle, upper rails 34 slidably mounted on the lower rails 32, and electromagnetic motors (not shown) for moving the lower rails 32 and the upper rails 34 relative to each other. By operating the electromagnetic motors, it is possible to slide the vehicle seat 20 in the longitudinal direction.

The pair of operating switches 10, 12, which serve to control the operation of the electromagnetic motors of the slide mechanism 30, are mounted on a side face of the seat cushion 22, to be arranged or aligned in the longitudinal direction of the vehicle. An anteriorly-located operating switch 10, as one of the operating switches 10, 12, is operable to slide the vehicle seat 20 forward, and a posteriorly-located operating switch 12, as the other switch, is operable to slide the vehicle seat 20 rearward. Since each of the operating switches 10, 12 has the same structure, the operating switch 10 as a typical one will be described.

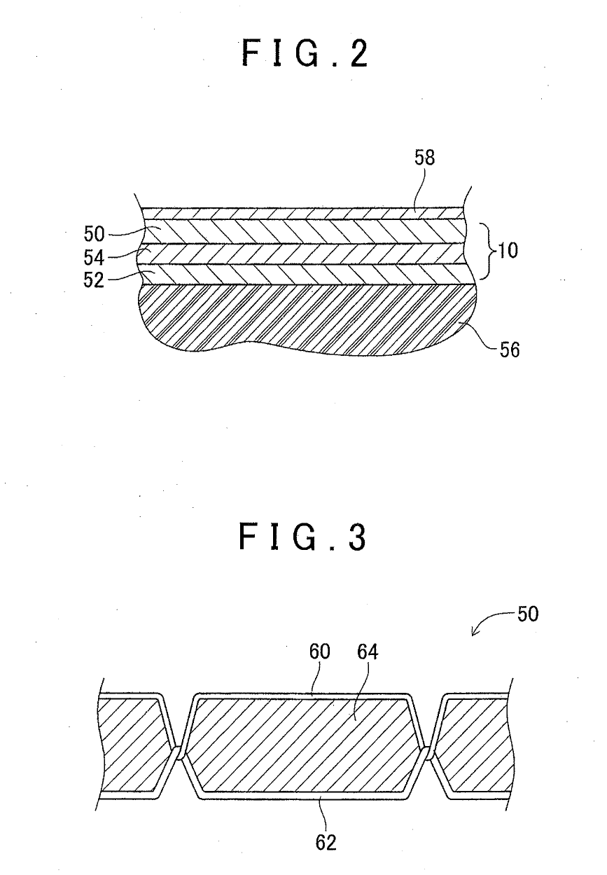

The operating switch 10 consists principally of three sheets of sheet-shaped members 50, 52, 54, as shown in FIG. 2, which is a cross-sectional view taken along line A-A in FIG. 1. The three sheets of sheet-shaped members 50, 52, 54, which are laminated on each other, are inserted between a seat pad 56 of the seat cushion 22, and a seat cover 58 that covers the seat pad 56. More specifically, the operating switch 10 consists of first and second conductive cloths 50, 52 having electric conductivity, and an insulating cloth 54 inserted between the two sheets of conductive cloths 50, 52. These three sheets of sheet-shaped members 50, 52, 54 are laminated on and attached to each other by stitching at respective edge portions. Then, the three sheets of sheet-shaped members 50, 52, 54 thus attached together by stitching are inserted between the seat pad 56 and the seat cover 58, such that the first conductive cloth 50 is in close contact with the seat cover 58, and the second conductive cloth 52 is in close contact with the seat pad 56.

The first conductive cloth .50 is formed by attaching a conductive thread (see FIG. 3) that can carry electric current, to a non-conductive cloth, by stitching, and has electric conductivity due to the use of the conductive thread 60 that can carry current. The method of stitching with the conductive thread 60 may be selected from various stitching methods, such as lock stitch, zigzag stitch, running stitch, and chain stitch. In the first conductive cloth 50, the conductive thread 60 is attached by lock stitching to the non-conductive cloth. More specifically, the conductive thread 60 is used as a needle thread for use in a sewing machine capable of lock stitching, while an ordinary machine sewing thread 62 (see FIG. 3) is used as a bobbin thread, and lock. stitching is performed on a non-conductive base cloth 64 (see FIG. 3). In this manner, the first conductive cloth 50 having a cross-section as shown in FIG. 3 is produced by sewing.

The conductive thread 60 may be formed of any material capable of carrying current, and may be selected from, for example, wire materials made of metal or alloy, carbon-fiber filament, those formed by plating a non-conductive wire material with metal, alloy, or the like, and those formed by twisting a wire material made of metal or alloy and a non-conductive wire material together. Also, the base cloth 64 may be an ordinary cloth material, and may be selected from various types of cloths, such as a woven fabric, knitted fabric, and a non-woven fabric.

In the first conductive cloth 50 constructed as described above, one surface of the base cloth 64 to which the conductive thread 60 is attached by stitching is in close contact with the seat cover 58. If an input medium, such as a finger of the user, approaches the location where the first conductive cloth 50 is mounted, namely, one side portion of the seat cushion 22 where the operating switch 10 is inserted between the seat pad 56 and the seat cover 58, the first conductive cloth 50 can detect the approaching input medium. More specifically, when the input medium approaches the location where the first conductive cloth 50 is mounted, the capacitance of the conducive thread 60 changes, and the approaching input medium is detected by detecting the change of the capacitance. Namely, the first conductive cloth 50 functions as a capacitive touch sensor.

On the other hand, the second conductive cloth 52 is a woven fabric using the conductive thread 60 used in the first conductive cloth 50 as a warp thread and a well thread, and almost the entire area of the surface of the second conductive cloth 52 is occupied by the conductive thread 60. Therefore, the second conductive cloth 52 consists of fibers having a considerably high conductivity, and is able to absorb electromagnetic waves at a considerably, high efficiency. This is because the highly conductive fibers absorb a relatively large amount of current generated by electromagnetic waves.

The first conductive cloth. 50 and the second conductive cloth 52 are insulated from each other by the insulating cloth 54 inserted therebetween, so that the sensitivity of the first conductive cloth 50 that functions as a touch sensor and the electromagnetic-wave absorbing effect of the second conductive cloth 52 do not deteriorate.

In the operating switch 10 constructed as described above, and the operating switch 12 having substantially the same structure as the operating switch 10, the first conductive cloth 50 that constitutes each of the operating switches 10, 12 functions as a touch sensor. When an input medium, such as a finger, comes close to either of the operating switches 10, 12, the operating switch 10, 12 is operable to slide the vehicle seat 20 forward or backward. The second conductive cloth 52 having a high conductivity is placed below the first conductive cloth 50, via the insulating cloth 54, so that electromagnetic waves are absorbed by the second conductive cloth 52. With this arrangement, it is possible to reduce an influence of electromagnetic waves generated within the vehicle on the first conductive cloth 50, and thus prevent malfunction of the slide mechanism 30.

Each of the operating switches 10, 12 consists of three sheets of sheet-shaped members 50, 52, 54, and is inserted between the seat pad 56 and the seat cover 58. With this arrangement, a sense of unevenness or roughness the user feels at the location where each operating switch 10, 12 is inserted, and an uncomfortable feeling, or the like, in touching at the location where each operating switch 10, 12 is inserted, can be suppressed or eased.

As described above, almost the entire surface area of the second conductive cloth 52 for absorbing electromagnetic waves is occupied by the conductive thread 60. On the other hand, in the first conductive cloth 50 that functions as a touch sensor, the conductive thread 60 is attached by stitching to the non-conductive base cloth 64. Therefore, the ratio of the area occupied by the conductive thread 60 to the surface area of the first conductive cloth 50 is made smaller than the ratio of the area occupied by the conductive thread 60 to the surface area of the second conductive cloth 52. With this arrangement, the first conductive cloth 50 in which the conductive thread 60 is provided at a relatively low density is less likely to be affected by electromagnetic waves, and the second conductive cloth 52 in which the conductive thread 60 is provided at a relatively high density is able to effectively absorb electromagnetic waves.

As shown in FIG. 1, the side face of the seat cushion 22 provided with the pair of operating switches 10, 12 is covered with a side shield 28, and an upper edge portion of the side shield 28 is cut out so that the mounting sites of the operating switches 10, 12 are exposed to the outside of the seat. More specifically, a cutout portion 70 that extends in the longitudinal direction of the vehicle is formed in the upper edge portion of the side shield 28, and the mounting site of the operating switch 10 is exposed to the outside of the seat, through a front end portion of the cutout portion 70, while the mounting site of the operating switch 12 is exposed to the outside of the seat, through a rear end portion of the cutout portion 70.

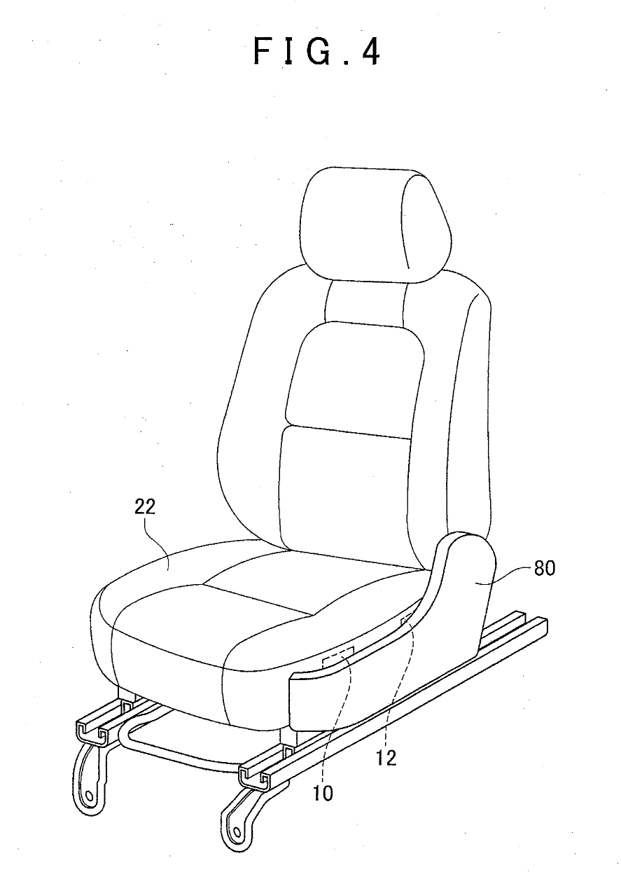

On the other hand, where a side shield 80 in which no cutout portion is formed is employed as a side shield that covers the side face of the seat cushion 22 on which the operating switches 10, 12 are mounted, as shown in FIG. 4, the most part of the side face of the seat cushion 22 is covered with the side shield 80. Therefore, only small portions of the mounting sites of the operating switches 10, 12 are exposed to the outside of the seat, and the operability of the operating switches 10, 12 is considerably deteriorated. Thus, the exposed areas of the mounting sites of the operating switches 10, 12 have a great influence on the operability of the operating switches 10, 12. Therefore, the cutout portion 70 is formed in the side shield 28 employed in the vehicle seat 20 of this embodiment, and the exposed areas of the operating switches 10, 12 are increased, so that the operability of the operating switches 10, 12 is improved.

The side shield 28 formed with the cutout portion 70 is positioned so that the operating switch 10 is exposed to the outside of the seat at a front end, portion of the cutout portion 70, and the operating switch 12 is exposed to the outside of the seat at a rear end portion of the cutout portion 70. Therefore, the operator can recognize the mounting site of each operating switch 10, 12, by feeling for the front or rear end portion of the cutout portion 70 of the side shield 28, and can gropingly operate the operating switches 10, 12 provided on one side of the seat cushion 22 which is difficult to visually confirm.

In the illustrated embodiment, the operating switch 10 is one example of operating switch, and the first conductive cloth 50, second conductive cloth 52, and the insulating cloth 54, which constitute the operating switch 10, are examples of fabric electrode, electromagnetic wave absorber, and spacer, respectively. The conductive thread 60 that constitutes the first conductive cloth 50 and the conductive thread 60 that constitutes the second conductive cloth 52 are one example of wire material. Also, the vehicle seat 20 is one example of vehicle seat.

It is to be understood that the invention is not limited to the illustrated embodiment, but may be embodied in various forms, with various changes or improvements made based on the knowledge of those skilled in the art. More specifically, in the illustrated embodiment, the slide mechanism 30 is employed as a mechanism that is operated by the operating switch 10, but other types of mechanisms may be employed. More specifically, a reclining mechanism capable of changing the angle of inclination of the seat back relative to the seat cushion, a lumbar support mechanism capable of adjusting the state of holding the lumbar of the seated person, a lifter mechanism capable of adjusting the height of the vehicle seat, a front tilt mechanism capable of changing the tilt amount of a front portion of the seat cushion, mechanisms for changing the length of the seat cushion as measured in the longitudinal direction, the intermediate folding angle of the seat back, the bending angle of the side support, the angle of inclination of the head rest, and so forth, a mechanism capable of adjusting the temperature of the vehicle seat, etc. may be employed.

In the first conductive cloth 50 of the illustrated embodiment, the conductive thread 60 is attached by stitching to the base cloth 64. However, the conductive thread 60 may be fixedly attached to the base cloth 64 by various methods. More specifically, the conductive thread 60 may be attached to the base cloth 64 with an adhesive, a low-melting-point polymer, or the like. While the second conductive cloth 52 is a woven fabric using the conductive thread 60 as warp thread and weft thread in the illustrated embodiment, the second conductive cloth 52 may be any sheet-shaped member at least a part of which uses the conductive thread 60. For example, the second conductive cloth 52 may be a sheet-shaped member using the conductive thread 60 as a part of at least one of warp thread and weft thread, and using a non-conductive thread for the remaining part of the sheet-shaped member.

While the first conductive cloth 50 is formed by attaching the conductive thread 60 to the base cloth 64 in the illustrated embodiment, the first conductive cloth 50 may be a woven fabric using the conductive thread 60, like the second conductive cloth 52. On the other hand, the second conductive cloth 52 is a woven fabric using the conductive thread 60 in the illustrated embodiment, but may be formed by attaching the conductive thread 60 to the base cloth 64. However, it is desirable, in view of the electromagnetic wave absorption rate, or the like, that the ratio of the area occupied by the conductive thread 60 to the surface area of the first conductive cloth 50 is smaller than the ratio of the area occupied by the conductive thread 60 to the surface area of the second conductive cloth 52.

In the illustrated embodiment, the second conductive cloth 52 is used as the electromagnetic wave absorber, while the insulating cloth 54 is used as the spacer, and the electromagnetic wave absorber and the spacer are in the form of sheet-shaped members. However, electromagnetic wave absorbers and spacers having various shapes may be employed. However, it is desirable, in view of the arrangement that the operating switch 10 is inserted between the seat pad 56 and the seat cover 58, that the electromagnetic wave absorber and the spacer have a thin shape, and that they are in the form of sheets or thin films.

While the operating switch 10, 12 is inserted between the seat pad 56 and the seat cover 58 in the illustrated embodiment, the first conductive cloth 50 of the operating switch 10, 12 maybe arranged to be exposed to the surface of the vehicle seat 20. Namely, the conductive thread 60 may be used as a part of a seat cover located on a side face of the seat cushion 22, so that this part of the seat cover functions as a touch sensor.

What is claimed is:

1. An operating switch provided on a vehicle seat, comprising:
a fabric electrode that includes a wire material that is able to carry electric current, and functions as a touch sensor that detects an input medium approaching or contacting with the fabric electrode;
an electromagnetic wave absorber capable of absorbing electromagnetic wave; and
a spacer that has an insulating property and is inserted between the fabric electrode and the electromagnetic wave absorber.

2. The operating switch according to claim 1, wherein each of the electromagnetic wave absorber and the spacer is a sheet-shaped member.

3. The operating switch according to claim 1, wherein:
the electromagnetic wave absorber is a sheet-shaped member comprising a wire material that is able to carry electric current; and
a ratio of an area occupied by the wire material that constitutes the fabric electrode, to a surface area of the fabric electrode, is smaller than a ratio of an area occupied by the wire material that constitutes the electromagnetic wave absorber, to a surface area of the electromagnetic wave absorber.
